(19) United States
(12) Patent Application Publication
(10) Pub. No.: US 2010/0301081 A1
(43) Pub. Date: Dec. 2, 2010

(54) Boat rack for pick-up trucks

(76) Inventors: Michael P. DeGroot, Uintah, UT (US); Matthew R. DeGroot, Riverdale, UT (US)

Correspondence Address: Michael P. DeGroot, 6803 South 1540 East, Uintah, UT, 84405, US

(21) Appl. No.: 12/454,845

(22) Filed: May 26, 2009

(51) Int. Cl. B60R 9/00

(52) U.S. Cl. 224/405

(57) ABSTRACT

A boat rack for use with a pick-up truck that will facilitate positioning and support of a small boat over the bed of the truck and onto the truck cab; the rack is inexpensive, lightweight and easy to assemble, disassemble and to put on or to remove from a pick-up truck bed; whereby a small boat placed on the rack and vehicle cab is readily tied down and secured in place while leaving sufficient clearance in the truck bed to permit positioning of one or more land vehicles in the truck bed to be transported simultaneously with the boat.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

### Field of the Invention

This invention relates to structures used to facilitate simultaneous transport of boats and land vehicles on pick-up trucks.

Many types of boat haulers have been used with vehicles to transport small boats, such as small fishing hard walled craft, inflated rafts, and inflated pontoon-type float boats simultaneously with the transport of land vehicles. Frequently, known boat and land vehicle haulers comprise a trailer to be towed behind a vehicle and to carry both a boat and a land vehicle. It has also been common to position various types of racks on the tops of station wagons, van type vehicles and pick-up trucks to provide a boat support structure.

The same pick-up truck used for hauling a small boat on an irregular or infrequent basis is also often used on a daily or regular basis for hauling other items, or even as just a personnel hauling, every day, means of transportation. Consequently, it is highly desirable that any structure used with the truck to make the truck suitable for transporting a boat be easily assembled to be compactly stored in the truck when the vehicle is being used for other purposes. The support rack not only must be easily assembled and disassembled, but must take up only a minimum space in the truck bed when stored so that the truck can still be used to carry other cargo, including one or more land vehicles.

Pick-up trucks have often been used to carry small boats with the bow or stem of the boat inserted into the pick-up bed and moved to be against the vehicle cab. The other end of the boat then often projects from the rear of the truck bed. With the boat in the pick-up bed there is very little room for anything else to be carried in the bed. It is, therefore, desirable to have a boat support structure for use with pick-up trucks that will allow for carrying of a small boat while still leaving the pick-up bed available to receive other cargo to be transported. More particularly, the boat support structure should be capable of carrying a small boat while allowing the truck bed to still carry one or more land vehicles, such as all terrain vehicles (ATV), and bicycles.

Pick-up trucks come in many configurations. The boat carrying structure for pick-up trucks should be usable with as many different pick-up truck configurations as possible. Thus the carrying structure should be usable for pick-up trucks having different sizes of truck beds and different cab arrangements.

### BRIEF SUMMARY OF THE INVENTION

Objects of the Invention

A principal object of the present invention is to provide a boat rack for use with a wide variety of pick-up truck configurations without disrupting the capability of the truck to carry one or more land vehicles and/or other cargo in the truck bed while a boat is simultaneously carried on the rack.

Another object is to provide a boat rack for use with pick-up trucks having long beds, short beds, single cabs, double cabs, or crew cabs.

Still another object is to provide a boat rack that is readily assembled to fit a pick-up truck bed and that is easily disassembled for storage when not installed for use in a truck bed.

Principal Features of the Invention

Principal features of the invention include a readily assembled and disassembled support frame that can be assembled to fit into pick-up truck beds of different lengths and widths.

Another feature is in the use of tubular telescoping support, legs, side rails and spacer members; and diagonal braces.

Additional objects and features of the invention will become apparent from the following drawings and detailed description.

### THE DRAWINGS

In the Drawings:

FIG. 1 is a perspective view of a pick-up truck with a boat rack of the invention mounted in the truck bed, and a lightweight inflatable boat carried by the rack and the truck;

FIG. 2, a perspective view of the assembled rack of the invention;

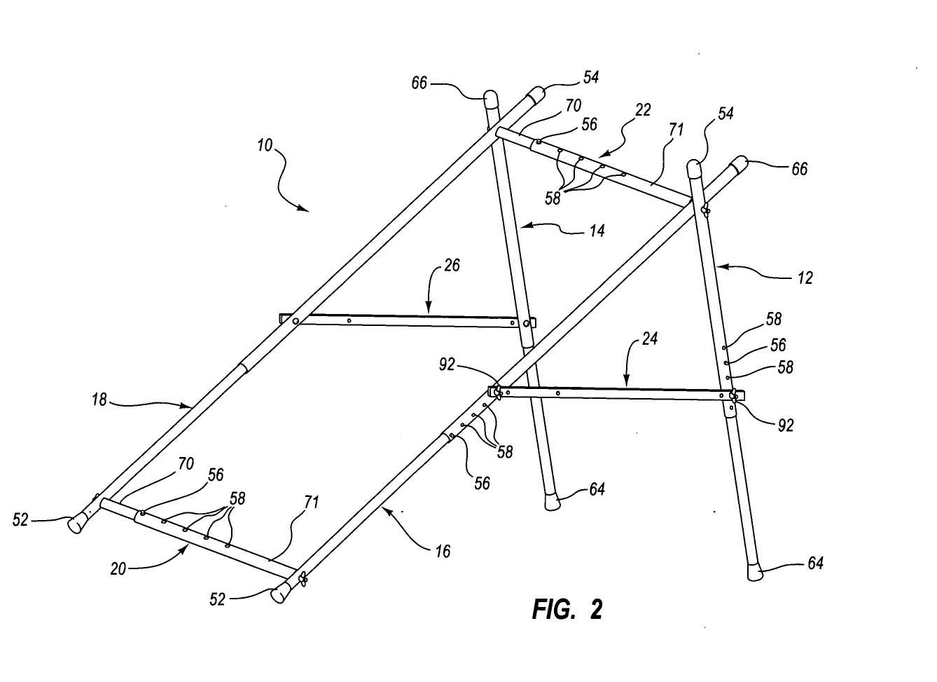

FIG. 3, a rear elevation view of a pick-up truck with a small boat on the rack of the invention, the rack being mounted in the truck bed and with an all terrain vehicle also positioned in the truck bed;

FIG. 4, a view like that of FIG. 3 showing a land vehicle, i.e., a bicycle, positioned in the truck bed; and

FIG. 5, a perspective view of the disassembled rack of the invention, including a storage bag for the disassembled rack components.

### DETAILED DESCRIPTION

Referring now to the Drawings

In the illustrated preferred embodiment of the invention, the boat rack, shown generally at 10 includes a pair of rear support legs 12 and 14; a pair of side supports 16 and 18; a pair of spacer members 20 and 22; and a pair of diagonal braces 24 and 26.

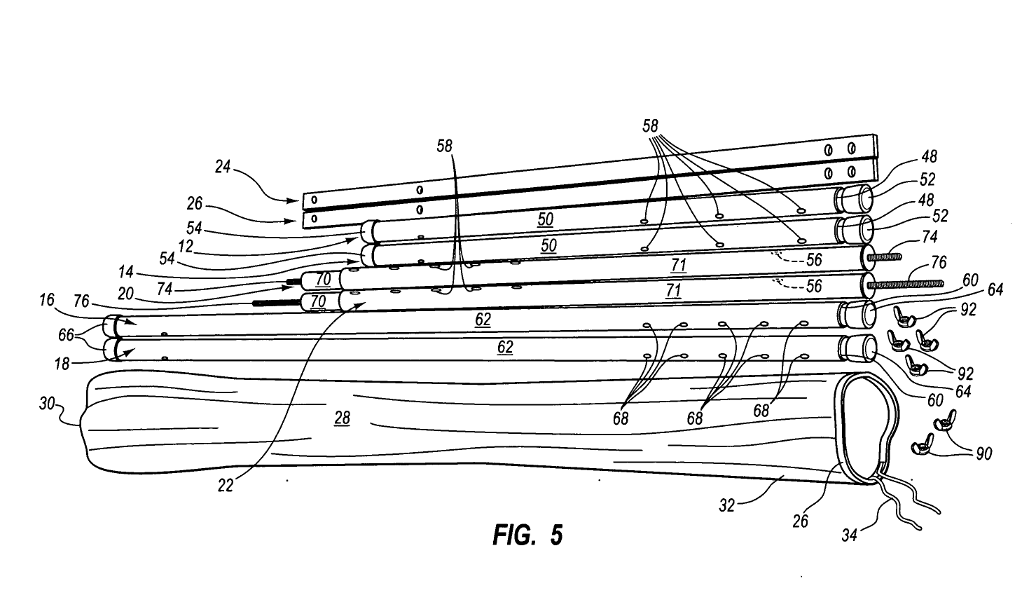

The rear support legs, diagonal side supports, spacer members and diagonal braces, when disassembled are all, together with the necessary connecting members, storable in an elongate bag 28 (FIG. 5). Bag 28 has a closed end 30 and an opposite end 32 with a drawstring 34 in a hem 36 that surrounds an opening 38 in the opposite end 32 of the bag. A conventional string lock (not shown) may be used on the drawstring 34 to releasably hold the drawstring in a pulled position, closing the opening 38 at end 32 of the bag and can be moved on the drawstring to increase the size of the opening 38. Alternatively, the ends of drawstring 34 can be pulled together and tied to close the opening 38.

Boat rack 10 is assembled on the bed 40 of a pick-up truck 42 by respectively positioning rear support legs 12 and 14 to be upright in opposite rear corners 44 and 46 of the bed 40. The rear support legs 12 and 14 are each formed from telescoping pole lengths 48 and 50 and have caps 52 and 54 on the ends of the formed poles. The inner telescoping lengths 48 may have conventional spring biased detents 56 projecting through the wall of the pole length to extend through a selected hole 58 of a series of holes 58 in the wall of the outer telescoping length 60 to fix the overall length of the rear support legs at a selected length.

The side supports 16 and 18, like the rear legs are preferably formed from telescoping inner pole lengths 60 and outer pole lengths 62. End caps 64 and 66 are respectively provided at opposite ends of the assembled side supports. Also, as with the rear legs, the telescoping lengths of the side supports preferably include conventional spring detents 56 projecting through the walls of the inner telescoping pole lengths 60 to snap through a selected hole 58 of a plurality of holes 58 through the outer telescoping pole length 62 to set the overall lengths of the side supports 16 and 18.

Spacer members 20 and 22 are each preferably formed as telescoping inner lengths of tubing 70 and outer receiving lengths of tubing 71 having closed ends 72 and with threaded studs 74 projecting from the ends of spacer 20. Threaded studs 76 project from the ends of spacer 22. As with the rear legs and side supports, the spacer members include conventional spring detents 56 to extend through the walls of the inner tubing lengths 76 and selected holes 58 of a series of holes 58 through the walls of outer lengths 71 to lock the inner and outer lengths of tubing together.

Diagonal braces 24 and 26 are elongate bars, preferably having a rectangular cross-sectional configuration. A plurality of holes 80 are spaced along and extend through the braces 24 and 26 to allow the braces to accommodate the selected overall length of the boat rack 10, as will be further hereinafter explained.

When the boat rack is assembled for use with the bed of a pick-up truck one end of each of the side supports is secured to an upper end of a rear support leg, with bolts, as shown at 90, inserted through selected holes through the end of the end legs 12 and 14, and corresponding holes through the ends of the side supports 16 and 18. Wing nuts 92, threaded onto bolts 90 hold the connected ends of the legs and the side supports together.

Spacer member 20 is set to desired length and is positioned to extend between the ends of side supports 16 and 18 not connected to the rear support legs. The threaded studs 76 are inserted through holes in the ends of the side supports and wing nuts 92 are threaded onto the studs to secure the space 20 to the side supports.

Spacer member 22 is set to desired length and is positioned to extend between the ends of side supports 16 and 18. Studs 76 extend through holes in the side supports and holes in the rear legs. The spacer member 22 is secured in place by using nuts 92 threaded onto the studs.

A diagonal brace 24,is secured between each rear legs and the side supports attached thereto. Bolts 90 are inserted through selected holes in the ends of the diagonal braces and the outer telescoping lengths of the side supports. The side supports extend downwardly from the upper ends of the rear legs when the legs are positioned in the rear corners 44 and 46 of the truck bed to place the spacer 20 and the attached ends of the side supports at the bottom front of the truck bed.

When the boat rack 10 is positioned in the bed 40 of a truck 42, the lengths of the rear legs are adjusted to place the spacer member 22 at or close to the height of the top 84 of the cab 86 of the truck 42.

A boat 90 is positioned to have one end of the boat resting on spacer 22 and the other end on the top 84 of cab 86.

Tie down straps 96 are passed over the boat and have their ends connected to anchors (not shown) provided therefore in the trucks. The tie down straps, which may be resilient or non-resilient, secure the boat 90 to the spacer member 22 and the top 84 of the cab 86.

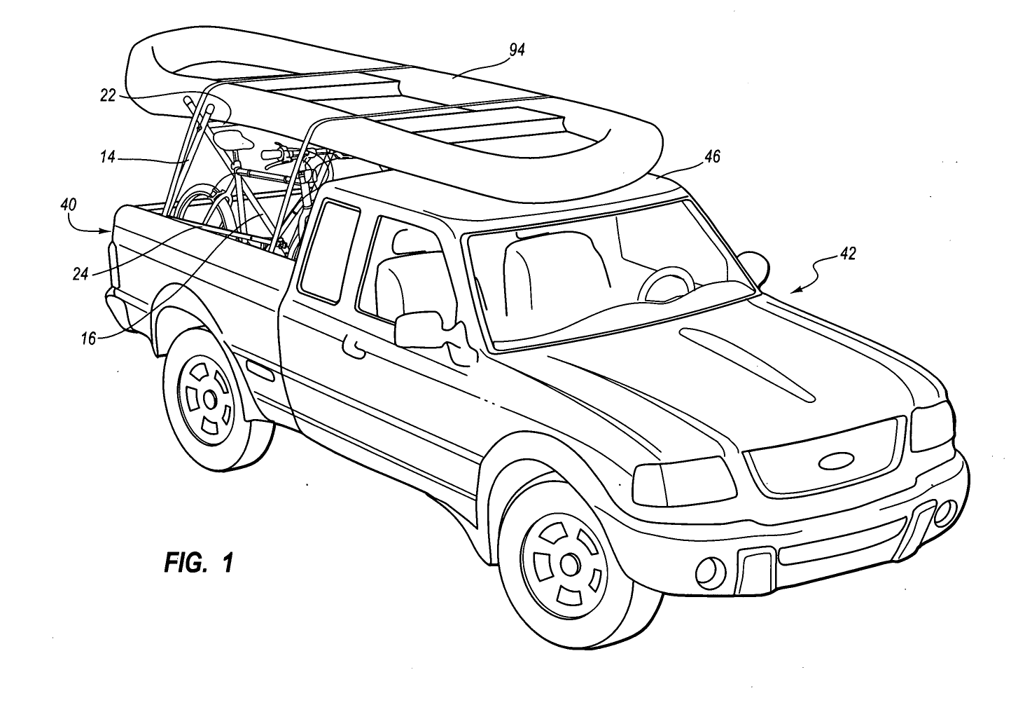

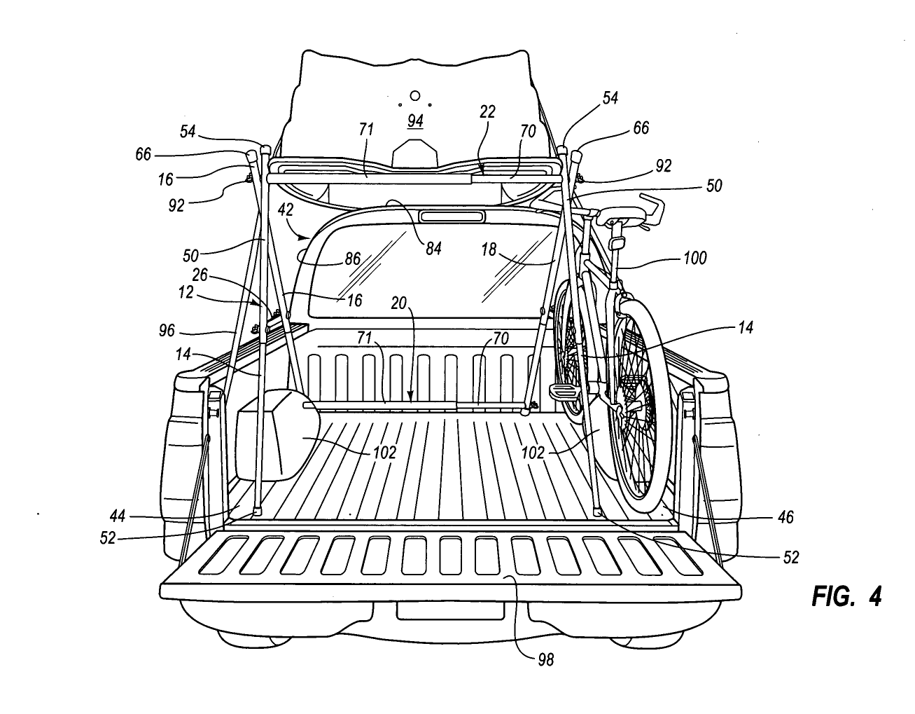

With the boat rack and boat so positioned, the tailgate 98 of the truck can be lowered and one or more land vehicles can be positioned in the truck bed, between the side supports. For example, as shown in FIGS. 1 and 4 a bicycle 100 can be positioned in the truck bed, either between the side supports of the rack, or outside the rack and astraddle a rear wheel well 102 of the truck 42.

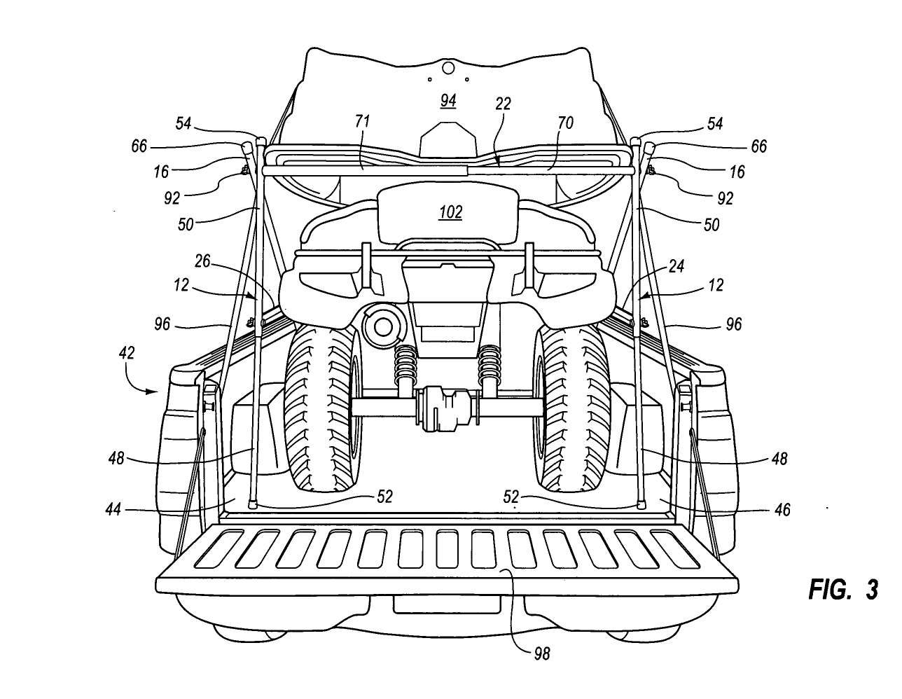

As shown in FIG. 3, an all terrain vehicle 104 can be positioned on the truck bed and between the side supports of the rack 10.

It will be apparent that more than one land vehicle, i.e., a pair of bicycles or a pair of motorcycles can also be positioned beneath a boat and between the side supports, if desired.

Although a preferred embodiment of our invention has been herein described, it is to be understood that the present disclosure is by way of example and that variations are possible without departing from the subject matter coming within the scope of the following claims, which subject matter we regard as our invention.

We claim:

1. A boat rack for use with a pick-up truck comprising
a pair of elongate rear support legs, each including a first end to fit in a rear corner of a pick-up truck bed;
a first spacer member interconnecting said other ends of said rear support legs;
a pair of side supports each having one end secured to a second end of a rear leg having a first end in a rear corner of the truck bed;
another spacer member interconnecting other ends of said side members remote from the ends of said side members connected to said rear legs; and
a diagonal brace interconnecting each rear support leg and said connected side support and extending from an intermediate portion of said rear leg to an intermediate portion of said side member.

2. A boat rack as in claim 1, wherein
the elongate rear support legs, the side supports and the spacer members are each formed from telescoping legs having an inner telescoping length telescoped within an outer telescoping length and including means to interlock said inner and outer lengths together to provide elongate rear support legs, side supports and spacers of selected lengths.

3. A boat rack as in claim 2, further including
means for selectively changing the length of each said diagonal brace between connections to rear support legs and the side supports whereby an angle formed between each leg and its connected side support is set, whereby said boat rack will fit in truck beds of different lengths and the lengths of the spacer members whereby said boat rack will fit in truck beds of different widths.
